(19) United States
(12) Patent Application Publication
(10) Pub. No.: US 2023/0010651 A1
(43) Pub. Date: Jan. 12, 2023

(54) System and Method for Online Optimization of Sensor Fusion Model

(71) Applicants: Biao ZHANG, West Hartford, CT (US); ABB Schweiz AG, Baden (CH)

(72) Inventors: Biao Zhang, West Hartford, CT (US); Saumya Sharma, Hartford, CT (US); Yixin Liu, Houghton, MI (US); Jianjun Wang, West Hartford, CT (US); Jorge Vidal-Ribas, Esplugues de Llobregat (ES); Jordi Artigas, Barcelona (ES); Ramon Casanelles, Sant Cugat del Vellès (ES)

(73) Assignee: ABB Schweiz AG, Baden (CH)

(21) Appl. No.: 17/772,656

(22) PCT Filed: Oct. 29, 2019
(86) PCT No.: PCT/US2019/058543

§ 371 Date: Apr. 28, 2022

(51) Int. Cl. G06N 3/08; G06N 3/04

(52) U.S. Cl. CPC G06N 3/08; G06N 3/04

(57) ABSTRACT

A system and method for collecting data regarding operation of a robot using, at least in part, responses from a first operation model to an input of sensed data from a plurality of sensors. The collected data can be used to optimize the first operation model to generate a second operation model. While the first operation model is being optimized, a train data-driven model that utilizes an end-to-end learning approach can be generated that is based, at least in part, on the collected data. Both the second operation model and the train data-driven model can be evaluated, and, based on such evaluation, a determination can be made as to whether the train data-driven model is reliable. Moreover, based on a comparison of the models, one of the second operation model and the train data-driven model can be selected for validation, and if validated, used in the operation of the robot.

### FIELD OF INVENTION

The present invention relates to optimization of robotic calibration, and more particularly, to a system and method for combining a train data-driven model that utilizes an end-to-end learning based approach and model based learning for optimization of sensor fusion.

### BACKGROUND

A variety of operations can be performed during the final trim and assembly (FTA) stage of automotive assembly, including, for example, door assembly, cockpit assembly, and seat assembly, among other types of assemblies. Yet, for a variety of reasons, only a relatively small number of FTA tasks are typically automated. For example, often during the FTA stage, while an operator is performing an FTA operation, the vehicle(s) undergoing FTA is/are being transported on a line(s) that is/are moving the vehicle(s) in a relatively continuous stop and go manner. Yet such continuous stop and go motions of the vehicle(s) can cause or create certain irregularities with respect to at least the movement and/or position of the vehicle(s), and/or the portions of the vehicle(s) that are involved in the FTA. Moreover, such stop and go motion can cause the vehicle to be subjected to movement irregularities, vibrations, and balancing issues during FTA, which can prevent, or be adverse to, the ability to accurately model or predict the location of a particular part, portion, or area of the vehicle that directly involved in the FTA. Further, such movement irregularities can prevent the FTA from having a consistent degree of repeatability in terms of the movement and/or positioning of each vehicle, or its associated component, as each subsequent vehicle and/or component passes along the same area of the assembly line. Accordingly, such variances and concerns regarding repeatability can often preclude the use of traditional teach and repeat position based robot motion control in FTA operations.

Accordingly, although various robot control systems are available currently in the marketplace, further improvements are possible to provide a system and means to calibrate the robot control system to accommodate such movement irregularities.

### BRIEF SUMMARY

An aspect of an embodiment of the present application is a method comprising collecting data regarding operation of a robot on a workpiece, the operation of the robot being based at least in part on responses from a first operation model to an input of sensed data from plurality of sensors of the robot. The method can also include optimizing the first operation model using at least a portion of the collected data to generate a second operation model. Additionally, while the first operation model is being optimized, a train data-driven model can be generated, the train data-driven model utilizing an end-to-end learning approach and is based, at least in part, on the collected data. Further, both the second operation model and the train data-driven model can be evaluated, and, one of the second operation model and the train data-driven model can be selected based on a result of the evaluation. The method can also include validating, using at least a portion of the collected data, the selected one of the second operation model and the train data-driven model for use in the operation of the robot.

Another aspect of an embodiment of the present application is a system comprising a robot having plurality of sensors and a controller, the controller being configured to operate the robot, at least in part, based on one or more responses from a first operation model to an input of a sensed data from the plurality of sensors. The system can also include one or more databases that are communicatively coupled to the robot, the one or more databases being configured to collect data regarding the operation of the robot on a workpiece. Additionally, the system can include one or more computational members that are communicatively coupled to the one or more databases and the robot. The one or more computational members can be configured to generate a second operation model that is based on an optimization of the first operation model using at least a portion of the collected data. Additionally, the one or more computational members can be configured to generate, in parallel with the generation of the second operation model, a train data-driven model that can be based on an end-to-end learning approach that utilizes at least a portion of the collected data. Further, the one or more computational members can be configured to evaluate both the second operation model and the train data-driven model, select, based on a result of the evaluation, one of the second operation model and the train data-driven model, and validate, using at least a portion of the collected data, the selected one of the second operation model and the train data-driven model for use in the operation of the robot.

These and other aspects of the present invention will be better understood in view of the drawings and following detailed description.

### BRIEF DESCRIPTION OF THE DRAWINGS

The description herein makes reference to the accompanying figures wherein like reference numerals refer to like parts throughout the several views.

FIG. 1 illustrates a schematic representation of at least a portion of an exemplary robotic system according to an illustrated embodiment of the present application.

FIG. 2 illustrates a schematic representation of an exemplary robot station through which vehicles are moved through by an automated or automatic guided vehicle (AGV), and which includes a robot that is mounted to a robot base that is moveable along, or by, a track.

FIG. 3 illustrates an exemplary process for using a combination a train data-driven model that utilizes an end-to-end learning based approach and model based learning for online optimization of sensor fusion.

The foregoing summary, as well as the following detailed description of certain embodiments of the present application, will be better understood when read in conjunction with the appended drawings. For the purpose of illustrating the application, there is shown in the drawings, certain embodiments. It should be understood, however, that the present application is not limited to the arrangements and instrumentalities shown in the attached drawings. Further, like numbers in the respective figures indicate like or comparable parts.

### DESCRIPTION OF THE ILLUSTRATED EMBODIMENTS

Certain terminology is used in the foregoing description for convenience and is not intended to be limiting. Words such as “upper,” “lower,” “top,” “bottom,” “first,” and “second” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

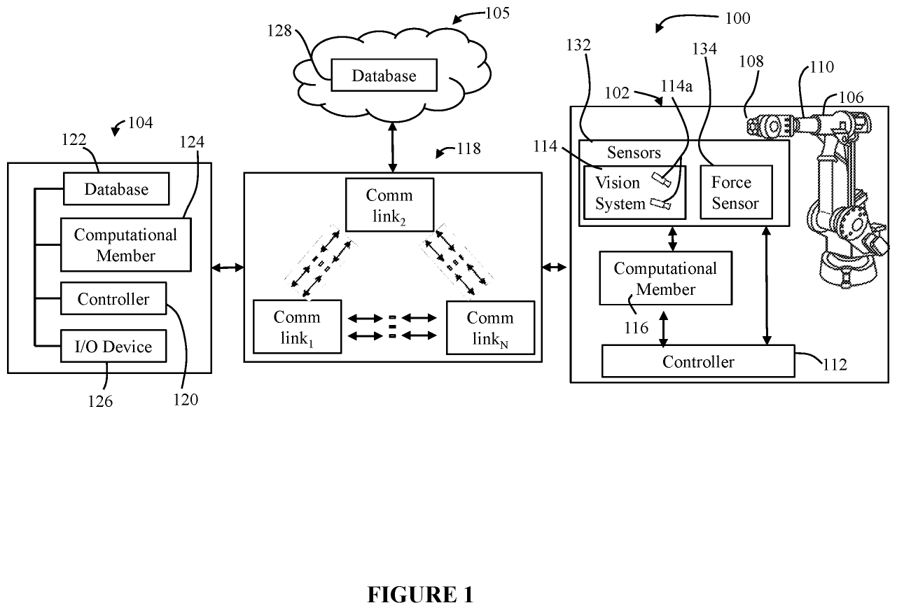

FIG. 1 illustrates at least a portion of an exemplary robotic system 100 that includes at least one robot station 102 that is communicatively coupled to at least one management system 104, such as, for example, via a communication network or link 118. The management system 104 can be local or remote relative to the robot station 102. Further, according to certain embodiments, the management system 104 can be cloud based. Further, according to certain embodiments, the robot station 102 can also include, or be in operable communication with, one or more supplemental database systems 105 via the communication network or link 118. The supplemental database system(s) 105 can have a variety of different configurations. For example, according to the illustrated embodiment, the supplemental database system(s) 105 can be, but is not limited to, a cloud based database.

According to certain embodiments, the robot station 102 includes one or more robots 106 having one or more degrees of freedom. For example, according to certain embodiments, the robot 106 can have, for example, six degrees of freedom. According to certain embodiments, an end effector 108 can be coupled or mounted to the robot 106. The end effector 108 can be a tool, part, and/or component that is mounted to a wrist or arm 110 of the robot 106. Further, at least portions of the wrist or arm 110 and/or the end effector 108 can be moveable relative to other portions of the robot 106 via operation of the robot 106 and/or the end effector 108, such for, example, by an operator of the management system 104 and/or by programming that is executed to operate the robot 106.

The robot 106 can be operative to position and/or orient the end effector 108 at locations within the reach of a work envelope or workspace of the robot 106, which can accommodate the robot 106 in utilizing the end effector 108 to perform work, including, for example, grasp and hold one or more components, parts, packages, apparatuses, assemblies, or products, among other items (collectively referred to herein as “components”). A variety of different types of end effectors 108 can be utilized by the robot 106, including, for example, a tool that can grab, grasp, or otherwise selectively hold and release a component that is utilized in a final trim and assembly (FTA) operation during assembly of a vehicle, among other types of operations.

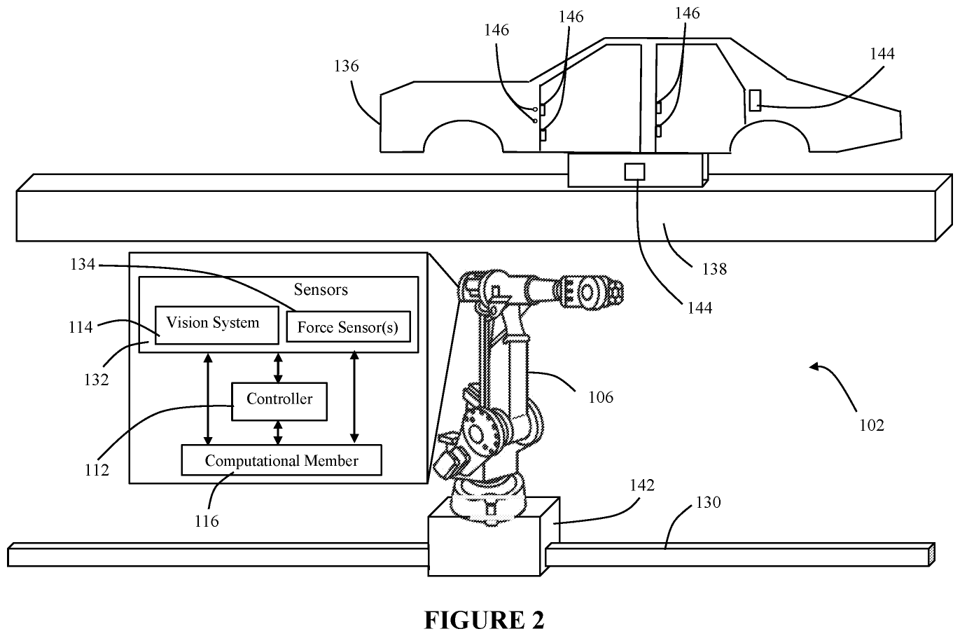

The robot 106 can include, or be electrically coupled to, one or more robotic controllers 112. For example, according to certain embodiments, the robot 106 can include and/or be electrically coupled to one or more controllers 112 that may, or may not, be discrete processing units, such as, for example, a single controller or any number of controllers. The controller 112 can be configured to provide a variety of functions, including, for example, be utilized in the selective delivery of electrical power to the robot 106, control of the movement and/or operations of the robot 106, and/or control the operation of other equipment that is mounted to the robot 106, including, for example, the end effector 108, and/or the operation of equipment not mounted to the robot 106 but which are an integral to the operation of the robot 106 and/or to equipment that is associated with the operation and/or movement of the robot 106. Moreover, according to certain embodiments, the controller 112 can be configured to dynamically control the movement of both the robot 106 itself, as well as the movement of other devices to which the robot 106 is mounted or coupled, including, for example, among other devices, movement of the robot 106 along, or, alternatively, by, a track 130 or mobile platform such as the AGV to which the robot 106 is mounted via a robot base 142, as shown in FIG. 2.

The controller 112 can take a variety of different forms, and can be configured to execute program instructions to perform tasks associated with operating robot 106, including to operate the robot 106 to perform various functions, such as, for example, but not limited to, the tasks described herein, among other tasks. In one form, the controller(s) 112 is/are microprocessor based and the program instructions are in the form of software stored in one or more memories. Alternatively, one or more of the controllers 112 and the program instructions executed thereby can be in the form of any combination of software, firmware and hardware, including state machines, and can reflect the output of discreet devices and/or integrated circuits, which may be co-located at a particular location or distributed across more than one location, including any digital and/or analog devices configured to achieve the same or similar results as a processor-based controller executing software or firmware based instructions. Operations, instructions, and/or commands determined and/or transmitted from the controller 112 can be based on one or more models stored in non-transient computer readable media in a controller 112, other computer, and/or memory that is accessible or in electrical communication with the controller 112.

According to the illustrated embodiment, the controller 112 includes a data interface that can accept motion commands and provide actual motion data. For example, according to certain embodiments, the controller 112 can be communicatively coupled to a pendant, such as, for example, a teach pendant, that can be used to control at least certain operations of the robot 106 and/or the end effector 108.

The robot station 102 and/or the robot 106 can also include one or more sensors 132. The sensors 132 can include a variety of different types of sensors and/or combinations of different types of sensors, including, but not limited to, a vision system 114, force sensors 134, motion sensors, acceleration sensors, and/or depth sensors, among other types of sensors. Further, information provided by at least some of these sensors 132 can be integrated, including, for example, via use of algorithms, such that operations and/or movement, among other tasks, by the robot 106 can at least be guided via sensor fusion. Thus, as shown by at least FIGS. 1 and 2, information provided by the one or more sensors 132, such as, for example, a vision system 114 and force sensors 134, among other sensors 132, can be processed by a controller 120 and/or a computational member 124 of a management system 104 such that the information provided by the different sensors 132 can be combined or integrated in a manner that can reduce the degree of uncertainty in the movement and/or performance of tasks by the robot 106.

According to the illustrated embodiment, the vision system 114 can comprise one or more vision devices 114a that can be used in connection with observing at least portions of the robot station 102, including, but not limited to, observing, parts, component, and/or vehicles, among other devices or components that can be positioned in, or are moving through or by at least a portion of, the robot station 102. For example, according to certain embodiments, the vision system 114 can extract information for a various types of visual features that are positioned or placed in the robot station 102, such, for example, on a vehicle and/or on automated guided vehicle (AGV) that is moving the vehicle through the robot station 102, among other locations, and use such information, among other information, to at least assist in guiding the movement of the robot 106, movement of the robot 106 along a track 130 or mobile platform such as the AGV (FIG. 2) in the robot station 102, and/or movement of an end effector 108. Further, according to certain embodiments, the vision system 114 can be configured to attain and/or provide information regarding at a position, location, and/or orientation of one or more calibration features that can be used to calibrate the sensors 132 of the robot 106.

According to certain embodiments, the vision system 114 can have data processing capabilities that can process data or information obtained from the vision devices 114a that can be communicated to the controller 112. Alternatively, according to certain embodiments, the vision system 114 may not have data processing capabilities. Instead, according to certain embodiments, the vision system 114 can be electrically coupled to a computational member 116 of the robot station 102 that is adapted to process data or information outputted from the vision system 114. Additionally, according to certain embodiments, the vision system 114 can be operably coupled to a communication network or link 118, such that information outputted by the vision system 114 can be processed by a controller 120 and/or a computational member 124 of a management system 104, as discussed below.

Examples of vision devices 114a of the vision system 114 can include, but are not limited to, one or more imaging capturing devices, such as, for example, one or more two-dimensional, three-dimensional, and/or RGB cameras that can be mounted within the robot station 102, including, for example, mounted generally above the working area of the robot 106, mounted to the robot 106, and/or on the end effector 108 of the robot 106, among other locations. Further, according to certain embodiments, the vision system 114 can be a position based or image based vision system. Additionally, according to certain embodiments, the vision system 114 can utilize kinematic control or dynamic control.

According to the illustrated embodiment, in addition to the vision system 114, the sensors 132 also include one or more force sensors 134. The force sensors 134 can, for example, be configured to sense contact force(s) during the assembly process, such as, for example, a contact force between the robot 106, the end effector 108, and/or a component being held by the robot 106 with the vehicle 136 and/or other component or structure within the robot station 102. Such information from the force sensor(s) 134 can be combined or integrated with information provided by the vision system 114 such that movement of the robot 106 during assembly of the vehicle 136 is guided at least in part by sensor fusion.

According to the exemplary embodiment depicted in FIG. 1, the management system 104 can include at least one controller 120, a database 122, the computational member 124, and/or one or more input/output (I/O) devices 126. According to certain embodiments, the management system 104 can be configured to provide an operator direct control of the robot 106, as well as to provide at least certain programming or other information to the robot station 102 and/or for the operation of the robot 106. Moreover, the management system 104 can be structured to receive commands or other input information from an operator of the robot station 102 or of the management system 104, including, for example, via commands generated via operation or selective engagement of/with an input/output device 126. Such commands via use of the input/output device 126 can include, but is not limited to, commands provided through the engagement or use of a microphone, keyboard, touch screen, joystick, stylus-type device, and/or a sensing device that can be operated, manipulated, and/or moved by the operator, among other input/output devices. Further, according to certain embodiments, the input/output device 126 can include one or more monitors and/or displays that can provide information to the operator, including, for, example, information relating to commands or instructions provided by the operator of the management system 104, received/transmitted from/to the supplemental database system(s) 105 and/or the robot station 102, and/or notifications generated while the robot 106 is running (or attempting to run) a program or process. For example, according to certain embodiments, the input/output device 126 can display images, whether actual or virtual, as obtained, for example, via use of at least the vision device 114a of the vision system 114.

According to certain embodiments, the management system 104 can include any type of computing device having a controller 120, such as, for example, a laptop, desktop computer, personal computer, programmable logic controller (PLC), or a mobile electronic device, among other computing devices, that includes a memory and a processor sufficient in size and operation to store and manipulate a database 122 and one or more applications for at least communicating with the robot station 102 via the communication network or link 118. In certain embodiments, the management system 104 can include a connecting device that may communicate with the communication network or link 118 and/or robot station 102 via an Ethernet WAN/LAN connection, among other types of connections. In certain other embodiments, the management system 104 can include a web server, or web portal, and can use the communication network or link 118 to communicate with the robot station 102 and/or the supplemental database system(s) 105 via the internet.

The management system 104 can be located at a variety of locations relative to the robot station 102. For example, the management system 104 can be in the same area as the robot station 102, the same room, a neighboring room, same building, same plant location, or, alternatively, at a remote location, relative to the robot station 102. Similarly, the supplemental database system(s) 105, if any, can also be located at a variety of locations relative to the robot station 102 and/or relative to the management system 104. Thus, the communication network or link 118 can be structured, at least in part, based on the physical distances, if any, between the locations of the robot station 102, management system 104, and/or supplemental database system(s) 105. According to the illustrated embodiment, the communication network or link 118 comprises one or more communication links 118 (Comm link_{1-N} in FIG. 1). Additionally, the system 100 can be operated to maintain a relatively reliable real-time communication link, via use of the communication network or link 118, between the robot station 102, management system 104, and/or supplemental database system(s) 105. Thus, according to certain embodiments, the system 100 can change parameters of the communication link 118, including, for example, the selection of the utilized communication links 118, based on the currently available data rate and/or transmission time of the communication links 118.

The communication network or link 118 can be structured in a variety of different manners. For example, the communication network or link 118 between the robot station 102, management system 104, and/or supplemental database system(s) 105 can be realized through the use of one or more of a variety of different types of communication technologies, including, but not limited to, via the use of fiber-optic, radio, cable, or wireless based technologies on similar or different types and layers of data protocols. For example, according to certain embodiments, the communication network or link 118 can utilize an Ethernet installation(s) with wireless local area network (WLAN), local area network (LAN), cellular data network, Bluetooth, ZigBee, point-to-point radio systems, laser-optical systems, and/or satellite communication links, among other wireless industrial links or communication protocols.

The database 122 of the management system 104 and/or one or more databases 128 of the supplemental database system(s) 105 can include a variety of information that may be used in the identification of elements within the robot station 102 in which the robot 106 is operating. For example, as discussed below in more detail, one or more of the databases 122, 128 can include or store information that is used in the detection, interpretation, and/or deciphering of images or other information detected by a vision system 114, such as, for example, features used in connection with the calibration of the sensors 132. Additionally, or alternatively, such databases 122, 128 can include information pertaining to the one or more sensors 132, including, for example, information pertaining to forces, or a range of forces, that are to be expected to be detected by via use of the one or more force sensors 134 at one or more different locations in the robot station 102 and/or along the vehicle 136 at least as work is performed by the robot 106. Additionally, information in the databases 122, 128 can also include information used to at least initially calibrate the one or more sensors 132, including, for example, first calibration parameters associated with first calibration features and second calibration parameters that are associated with second calibration features.

The database 122 of the management system 104 and/or one or more databases 128 of the supplemental database system(s) 105 can also include information that can assist in discerning other features within the robot station 102. For example, images that are captured by the one or more vision devices 114a of the vision system 114 can be used in identifying, via use of information from the database 122, FTA components within the robot station 102, including FTA components that are within a picking bin, among other components, that may be used by the robot 106 in performing FTA.

FIG. 2 illustrates a schematic representation of an exemplary robot station 102 through which vehicles 136 are moved by an automated or automatic guided vehicle (AGV) 138, and which includes a robot 106 that is mounted to a robot base 142 that is moveable along, or by, a track 130 or mobile platform such as the AGV. While for at least purposes of illustration, the exemplary robot station 102 depicted in FIG. 2 is shown as having, or being in proximity to, a vehicle 136 and associated AGV 138, the robot station 102 can have a variety of other arrangements and elements, and can be used in a variety of other manufacturing, assembly, and/or automation processes. Further, while the depicted robot station 102 can be associated with an initial set-up of a robot 106, the station 102 can also be associated with use of the robot 106 in an assembly and/or production process.

Additionally, while the example depicted in Figure illustrates a single robot station 102, according to other embodiments, the robot station 102 can include a plurality of robot stations 102, each station 102 having one or more robots 106. The illustrated robot station 102 can also include, or be operated in connection with, one or more AGV 138, supply lines or conveyors, induction conveyors, and/or one or more sorter conveyors. According to the illustrated embodiment, the AGV 138 can be positioned and operated relative to the one or more robot stations 102 so as to transport, for example, vehicles 136 that can receive, or otherwise be assembled with or to include, one or more components of the vehicle(s) 136, including, for example, a door assembly, a cockpit assembly, and a seat assembly, among other types of assemblies and components. Similarly, according to the illustrated embodiment, the track 130 can be positioned and operated relative to the one or more robots 106 so as to facilitate assembly by the robot(s) 106 of components to the vehicle(s) 136 that is/are being moved via the AGV 138. Moreover, the track 130 or mobile platform such as the AGV, robot base 142, and/or robot can be operated such that the robot 106 is moved in a manner that at least generally follows of the movement of the AGV 138, and thus the movement of the vehicle(s) 136 that are on the AGV 138. Further, as previously mentioned, such movement of the robot 106 can also include movement that is guided, at least in part, by information provided by the one or more force sensor(s) 134.

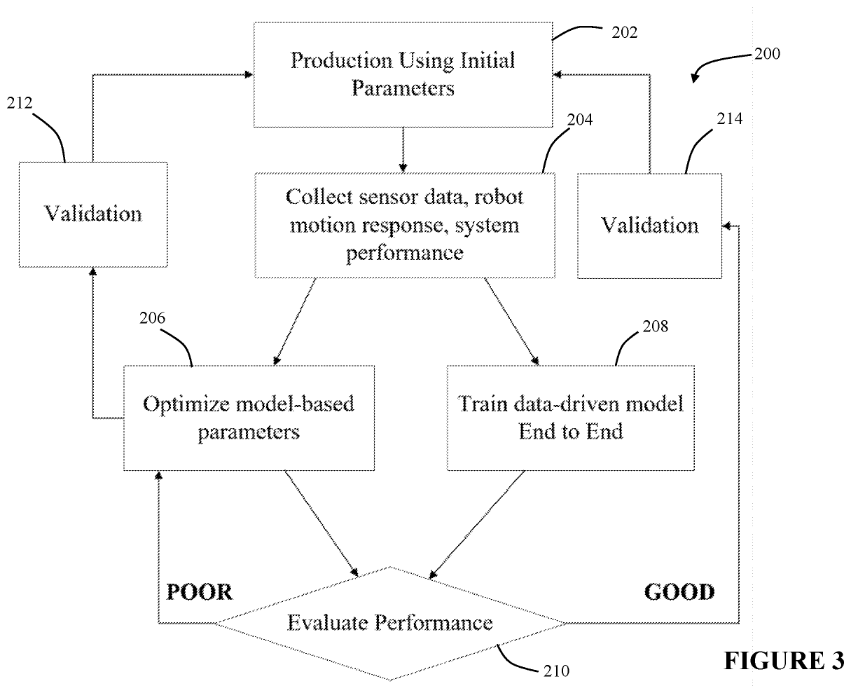

FIG. 3 illustrates an exemplary process 200 for using a combination of a train data-driven model that utilizes an end-to-end learning based approach and model based learning for online optimization of sensor fusion. The operations illustrated for all of the processes in the present application are understood to be examples only, and operations may be combined or divided, and added or removed, as well as re-ordered in whole or in part, unless explicitly stated to the contrary. Further, according to certain embodiments, the process 200 discussed herein can be utilized at a variety of different time periods during the lifetime or and/or stages of operation of the robot 106, and/or in a variety of different settings. As demonstrated below, the illustrated process 200 can provide a self-sufficient optimization for an automation system using multiple sensor input guidance.

At step 202, the robot 106 of the robot station 102 can be operated utilizing information from at least sensors 132 that were calibrated using initial parameters. While the initial parameters can be utilized to calibrate the sensors 132 at a variety of different time periods, according to the illustrated embodiment, such calibration based on initial parameters can occur in conjunction with preparing, or programing, the robot 106 for introduction or incorporation into the specific assembly operation for which the robot 106 will be operated, such as, for example, an FTA operation. Thus, for example, with respect to force sensors 134, the force sensors 134 can be initially calibrated such that a force(s) detected by the force sensor(s) 134 associated with the robot 106, end effector 108, or component attached thereto when contacting a work piece, such as, for example, a vehicle 136, will be within a force range and/or threshold that satisfies an initial force parameter. Other types of sensors however can be calibrated in different manners.

The information provided by a plurality of the one or more calibrated sensors 132 can be utilized by a sensor fusion model that indicates how the robot 106 should react, such as, for example, be moved or positioned, in response to at least the information provided by the calibrated sensors 132. Thus, accordingly to at least certain embodiments, the sensor fusion model can at least partially be based on the initial parameters that were utilized to calibrate the sensors 132. Such a sensor fusion model thus may be configured, at least at the initial stages of production in step 202, to move or position the robot 106 in a manner that allows the robot 106 to at least accurately and/or timely preform the task or operation that the robot 106 is programmed to perform, such as, for example, perform a FTA assembly operation.

According to certain embodiments, following at least calibration of the sensors 132 using the initial parameters, the robot 106 can be introduced, or incorporated into, an assembly process so that the robot 106 can proceed with performing the operations or tasks that the robot 106 has been programmed to perform while also utilizing the senor fusion model. In connection with the robot 106 performing these tasks, at step 204 data or information generated or otherwise associated with the operation of the robot 106 can be collected, recorded, and/or stored via use of an online monitoring tool and optimization function. For example, such information and data can be collected and stored in the database 122 of the management system 104 and/or the one or more databases 128 of the supplemental database system(s) 105, which, again, for example, can be a cloud-based database. Further, the information and data can be collected at step 204 at various intervals or at various times. For example, with respect to the exemplary embodiment depicted in FIG. 2, the information and data collected at step 204 can occur each time the robot 106 performs a task for each vehicle 136 that passes through the robot station 102 along the AGV 138.

The type of information and data collected and stored can vary, and can include, for example, data sensed or detected by one or more of the sensors 132, including, for example, but not limited to, information and data detected by the vision system 114 and the force sensor(s) 134. Additionally, such data and information can also include robot motion data, including, but not limited to, robot motion response data, which can include information relating to the response of the robot 106 to motion commands and/or instructions. Additionally, according to certain embodiments, the collected data or information can, for example, include information relating to system performance, including, but not limited to, performance of the robot 106 in connection with preforming one or more, if not all, robotic tasks that the robot 106 is to perform in connection with an assembly operation or procedure, among other tasks. For example, the collected data and information can provide an indication of the accuracy, duration, and/or responsiveness of the robot 106 in connection with the robot 106 recognizing a component to be grasped by the robot 106 for use in an assembly process, the robot 106 being moved and/or positioned to grasp the component, the robot 106 grasping the component, the robot 106 locating a location on the workpiece to which the grasped component is to be assembled, and the robot 106 being moved and/or positioned to secure the component at the located location on the workpiece, among other possible tasks and operations. The collected data and information, which can be utilized in development of the below discussed models, can also include, for example, information relating to path compensation, which can relate to deviations or changes in the path taken by the robot 106 in connection with the robot 106 performing its associated assembly operations or tasks, and/or can include information regarding delay compensation.

The collected data and information can indicate changes, if any, in the robot station 102 and/or in the operation and/or movement of the robot 106. For example, with respect to the exemplary embodiment depicted in FIG. 2, the data and information collected at step 204 can reflect changes in the lighting in the robot station 102, and thus associated changes in the ability of the vision system 114 to accurately detect certain features or images, changes in the speed at which the AGV 138 operates and/or changes in the speed of motion of the vehicle 136 as the vehicle passes through the robot station 102, and/or changes in the degree of vibration of the vehicle 138 while being tracked, or operably engaged during an assembly operation, by the robot 106, among other changes. Additionally, such data and information can provide an indication of drift in the performance of one or more of the sensors 132. Such changes may, for at least purpose of accuracy, necessitate a change in the sensor fusion model, and in particular, a change or tuning relating to the parameters that were initially used derive the sensor fusion model. Such indicated changes can also be communicated to an operator of the robot station 106 as notification that preventive maintenance may be required. Conversely, in the absence of such changes, or the relatively minimal extent of such changes, such as when the robot station 102 and associated assembly process or operation are working normally, such changes with respect to the sensor fusion model may be unwarranted and/or unnecessary. Thus, at least in normal operating conditions, the robot 106 can generally continue to operate using the initial sensor fusion model.

At step 206, using the data and information collected at step 204, the sensor fusion model used at step 202 can be optimized by changing or adjusting the parameters that were at least initially used to create the sensor fusion model. Such refinement of the sensor fusion model can result in the generation of an optimized sensor fusion model that more accurately reflects the actual conditions that are being detected or experienced in the robot station 102. Moreover, such refinement of the parameters based on the collected information and data from step 204, can result in the generation of an optimized sensor fusion model that may improve in the accuracy, reliability, and/or the performance of the robot 106. Similar to the collection of information and data at step 204, such refinement of the sensor fusion model at step 206 can, according to certain embodiments, occur at a location that is remote from the robot station 102, such as, for example, be cloud based, so as to not increase the computation and/or communication load at the robot station 102.

In parallel, or simultaneously, with the optimization of the sensor fusion model that occurs at step 206, at step 208 the information and data collected at step 204 can be utilized to develop a train data-driven model that utilizes end-to-end deep learning and/or reinforcement learning, among other types of learning, based approach(es) to guide movement and/or positioning of the robot 106 in connection with the previously discussed operations or tasks that the robot 106 is to perform. Similar to optimization of the sensor fusion model, the train data-driven model can be developed to account for changes that have occurred in the robot station 102, including, but not limited to, changes relating to lighting, motion irregularities, vibrations, and drift in the performance of one or more of the sensors 132 (particularly if the sensors 132 have not been calibrated in a long time), among other changes. Further, according to certain embodiments, such a train data-driven model can utilize neural networks to cluster and classify layers of collected and stored data that can include the data collected at step 204. Using such an approach, the train data-driven model can, for example, develop a machine based deep and/or reinforcement learning that is able to recognize correlates between certain inputted information and optimal results that may be obtained by responsive actions or performances by the robot 106, such, as, for example, optimal movement or positioning of the robot 106 in response to inputted or sensed information.

The train data-driven model approach can also build the layers of collected and stored data based upon the information and data collected at step 204 in a cloud database system(s) 105, as well as utilized cloud based computation and/or communication so as to not increase the computation and/or communication load at the robot station 102. Further, use of cloud based computation, communication, and/or evaluation by step 208 and other various steps of the process 200 can allow the various steps of the process 200 to occur without interruption in the production or assembly operations that are being performed by the robot 106, and while also minimizing need for human input in the process 200.

At step 210, which can according to certain embodiments be performed utilizing cloud based, edge based, or local computation and/or communication, among other manners of computation and communication, the optimized sensor fusion model outputted from step 206 is evaluated with respect to the train data-driven model derived from the end-to-end deep and/or reinforcement learning based approach(es) that is outputted from step 208. This comparison(s) between the models outputted from steps 206 and 208 of the process 200 at step 210 can, for example, be based on one or both of a statistical and quantitative evaluation and/or analysis of each of the models. Further, such analysis can, according to certain embodiments, be based on use of theoretical models or simulations that can, when applied to the models outputted at steps 206 and 208, provide an estimation or prediction of the anticipated behavior of the robot 106, including, for example, the anticipated accuracy and/or responsiveness in the movement, positioning, and/or decisions of the robot 106 when utilizing each of the models. Moreover, such an evaluation or analysis can include a comparison of the estimated or anticipated level of performance that may be obtained by the robot 106 when utilizing each of the optimized sensor fusion model and the train data-driven model while performing one or more operations or tasks that the robot 106 is to perform while being used in an assembly procedure.

The comparison or evaluation performed at step 210 can also include a characterization or rating of the results attained by use of the train data-driven model outputted from step 208 relative to the results attained by use of the optimized sensor fusion model outputted from step 206. Moreover, according to certain embodiments, such an evaluation can include a determination of whether the results in robot 106 performance that are expected or anticipated to be attained by use of the train data-driven model are, or are not, close to, far below, or exceeds, the results in robot 106 performance that are expected or anticipated to be attained by use of the optimized sensor fusion model. Such a characterization can be based on a variety of different criteria, such as, for example, if at least some, or certain, results attained in the evaluation of the train data-driven model are within a particular or predetermined numerical or statistical range of the results attained in the evaluation of the optimized sensor fusion model. Further, according to certain embodiments, such an evaluation can involve ranking the results attained from the evaluation of both the train data-driven model and the optimized sensor fusion model, determining the extent of the differences between those rankings and/or the associated results, including, for example, statistical or numerical results, and determining whether those differences are, or are not, within a particular or predetermined range, or satisfy some other threshold or threshold value.

Additionally, according to certain embodiments, the evaluation performed at step 210 can include a key performance index (KPI) evaluation. Such evaluation can include evaluation of one or more cycle times, such as, for example, the cycle it takes to progress the vehicle 136 through various workstations, and/or the cycle that it takes the robot 106 to grasp a workpiece, move it to the vehicle 136, install the workpiece, and return to a starting position, are contemplated, among other cycle times. Such KPI can also include other measures, including, but not limited to, the contact force associated with assembling the workpiece to the vehicle 136, as well as the success rate of the assembly.

If, based on the evaluation at step 210, the performance of the train data-driven model is determined to be relatively poor in comparison to the performance of the optimized sensor fusion model, such as, for example, produces results that are outside of a predetermined range or threshold of the results attained in the evaluation of the optimized sensor fusion model, then the train data-driven model is not selected for possible use in the operation of the robot 106. In such a situation, the optimized sensor fusion model may however remain in consideration for use in the operation of the robot 106.

As the process 200 can be continuous, the outcome of the evaluation at step 210 can be anticipated, for at least a certain initial period of time, to result in the selection of the optimized sensor fusion model at least until the anticipated performance of the train data-driven model reaches a level indicates that the train data-driven model is reliable. Such development of a reliable train data-driven model can coincide with the continuous collection of data and information relating to the actual operation of the robot 106 and/or the continuous utilization of the process 200 described herein, which can also result in a further refinement of the train data-driven model.

Accordingly, in the event the evaluation at step 210 is favorable to the optimized sensor fusion model and/or indicates that the train data-driven model is, at least at this time, unreliable, the process 200 can then proceed to step 212, at which the performance of the optimized sensor fusion model that was outputted at step 206 can be validated. According to certain embodiments, such validation of the optimized sensor fusion model can include, for example, analyzing the performance of the optimized sensor fusion model in response to actual data and information attained during operation of the robot 106, including for example, actual data and information obtained from the sensors 132. Further, such validation can involve repeated analysis of the performance of the optimized sensor fusion model in response to different actual data that is obtained from operation of the robot 106. Such data utilized in the validation of the optimized sensor fusion model may or may not be the same as, or similar to, the data that was, or is continuing to be, collected at step 204. Additionally, such validation at step 212 can include, for example, but is not limited to, evaluating the accuracy of the anticipated guided movement or positioning of the robot 106, and/or the anticipated degree of error associated with the performance of the tasks or operations of the robot 106 if the robot 106 were to use the optimized sensor fusion model. Such validation can further require that the anticipated performance attained through use of the optimized sensor fusion model satisfy predetermined criteria and/or thresholds.

If the optimized sensor fusion model is validated at step 212, the optimized sensor fusion model may replace the sensor fusion model that was being used in the operation of the robot 106, such as, for example, the initial sensor fusion model that was being used at step 202. Otherwise, if the optimized sensor fusion model is not validated at step 212, the robot 106 can continue to be operated without a change in the existing sensor fusion model, among other models, that the robot 106 is currently actually using.

Conversely, if, based on the evaluation at step 210, the performance of the train data-driven model is determined to be relatively good in comparison to the performance of the optimized sensor fusion model, such as, for example, produces results that exceed or are within a predetermined range or threshold of the results attained in the evaluation of the optimized sensor fusion model, then the train data-driven model, and not the optimized sensor fusion model, can be selected for possible use in the operation of the robot 106. In such a situation, at step 214, the train data-driven model may undergo validation in which train data-driven model can be validated in a manner that is similar to that discussed above with respect to the validation of the optimized sensor fusion model at step 212. Moreover, at step 214, the performance of the train data-driven model in response to actual data and information attained during operation of the robot 106, including for example, actual data and information obtained from the sensors 132, can be evaluated. Again, such analysis can include, for example, but is not limited to, the accuracy in the anticipated guided movement or positioning of the robot 106, and/or the anticipated degree of error associated with the performance of the tasks or operations of the robot 106 if the robot 106 were to use the train data-driven model. Such validation can further require that the anticipated performance attained through use of the train data-driven model satisfy predetermined criteria and/or thresholds.

If the train data-driven model is validated at step 214, the train data-driven model may replace the sensor fusion model that was being used in the operation of the robot 106, such as, for example, the initial sensor fusion model, among other models, that was being used at step 202. Otherwise, if the train data-driven model is not validated at step 214, the robot 106 can continue to be operated without a change in the existing model, such as, for example, without changing the sensor fusion model that is currently actually being used by the robot 106

As previously discussed, the illustrated process 200 can be continuous such that, over time and as more information and data is collected, the data-driven model may become more reliable than the sensor fusion model and/or the optimized sensor fusion model(s) that may have previously been developed. Further, the data-driven model, whether based on end-to-end deep learning or reinforcement learning, can also continuously be optimized. Thus, for example, embodiments of the subject application provide a process 200 for self-sufficient optimization of an automation system. Further, the possible use of the process 200 as an online monitoring tool and optimization function that utilizes cloud based computation, communication, and/or storage can prevent, or minimize, the process 200 from interfering with the actual assembly operations or tasks that are being, or are to be, performed by the robot 106, and thus reduces or prevents any associated downtime. The refinements and optimizations generated by the process 200 can also result in the process outputting preventative maintenance suggestions while also improving the robustness of the operation in a potentially varying manufacturing environment, as discussed above.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. A method comprising:
collecting data regarding operation of a robot on a workpiece, the operation of the robot being based at least in part on responses from a first operation model to an input of sensed data from a plurality of sensors of the robot;
optimizing the first operation model using at least a portion of the collected data to generate a second operation model;
generating, while optimizing the first operation model, a train data-driven model, the train data-driven model utilizing an end-to-end learning approach and is based, at least in part, on the collected data;
evaluating both the second operation model and the train data-driven model;
selecting, based on a result of the evaluation, one of the second operation model and the train data-driven model; and
validating, using at least a portion of the collected data, the selected one of the second operation model and the train data-driven model for use in the operation of the robot.

2. The method of claim 1, wherein the collected data is stored in a cloud based database, and wherein at least the steps of optimizing the first operational model, generating the train data-driven model, and evaluating the second operation model and the train data-driven model are performed by a cloud based computation system.

3. The method of claim 1, wherein evaluating comprises comparing an anticipated accuracy of the train data-driven model an anticipated accuracy of the second operation model.

4. The method of claim 3, wherein comparing comprises comparing an outcome of at least one of a statistical evaluation, a quantitative evaluation, and a simulation for each of the second operation model and the train data-driven model.

5. The method of claim 1, wherein the end-to-end learning approach is at least one of an end-to-end deep learning approach and an end-to-end reinforcement learning approach.

6. The method of claim 1, wherein the first operation model is based at least in part on a first set of sensor parameters, and wherein the second operation model is based on a second set of sensor parameters, at least some of the second set of sensor parameters being a modification of at least some of the first set of sensor parameters.

7. The method of claim 6, wherein the modification of least some of the first set of sensor parameters is based at least in part on at least one of a change in a robot station in which the robot operates and a change in a movement of the workpiece.

8. The method of claim 6, wherein the modification of at least some of the first set of sensor parameters is based at least in part on sensor drift of at least one of the plurality of sensors of the robot.

9. The method of claim 1, further including the step of operating, at least in part, the robot using the validated one of the second operation model and the train data-driven model.

10. The method of claim 1, wherein the operation of the robot is a final trim assembly operation for a vehicle, and wherein the step of collecting the data comprises collecting data from the robot for each vehicle that the robot performs the final trim assembly operation.

11. The method of claim 1, wherein the collected data comprises data from the plurality of sensors, motion data for the robot, and data relating to a performance of the robot in performing an assembly task.

12. A system comprising:
a robot having a plurality of sensors and a controller, the controller configured to operate the robot, at least in part, based on one or more responses from a first operation model to an input of a sensed data from the plurality of sensors;
one or more databases communicatively coupled to the robot, the one or more databases configured to collect data regarding the operation of the robot on a workpiece; and
one or more computational members communicatively coupled to the one or more databases and the robot, the one or more computational members configured to:
generate a second operation model based on an optimization of the first operation model using at least a portion of the collected data;
generate, in parallel with the generation of the second operation model, a train data-driven model, the train data-driven model being based on an end-to-end learning approach that utilizes at least a portion of the collected data;
evaluate both the second operation model and the train data-driven model;
select, based on a result of the evaluation, one of the second operation model and the train data-driven model; and
validate, using at least a portion of the collected data, the selected one of the second operation model and the train data-driven model for use in the operation of the robot.

13. The system of claim 12, wherein the one or more databases comprises a cloud based database.

14. The system of claim 13, wherein the one or more computational members comprises a cloud based computational member.

15. The system of claim 12, wherein the first operation model is a first sensor fusion model that is based, at least in part, on a first set of parameters.

16. The system of claim 15, wherein the second operation model is a second sensor fusion model, the second sensor fusion model based on a second set of parameters, the second set of parameters being, at least in part, a modification of at least a portion of the first set of parameters that is based on data collected by the one or more databases.

17. The system of claim 15, wherein the second operation model is a second sensor fusion model, the second sensor fusion model based on a second set of parameters, the second set of parameters being, at least in part, a modification of the first set of parameters, the modification being based at least in part on a sensor drift of at least one of the plurality of sensors of the robot.

18. The system of claim 15, wherein the train data-driven model is based on at least one of an end-to-end deep learning approach and an end-to-end reinforcement learning approach.

19. The system of claim 12, wherein the controller is further configured to:
replace the first operation model with the validated one of the second operation model and the train data-driven model; and
operate the robot, at least in part, based on one or more responses from the validated one of the second operation model and the train data-driven model to an input of the sensed data from the plurality of sensors.

20. The system of claim 12, wherein the operation performed by the robot is a final trim assembly operation for a vehicle, and wherein the one or more databases are configured to collect data from the plurality of sensors, motion data for the robot, and data relating to a performance of the robot in performing the final trim assembly operation.
